(19) United States
(12) Patent Application Publication
(10) Pub. No.: US 2026/0321647 A1
(43) Pub. Date: Oct. 15, 2026

(54) SURFACE-MODIFIED SILICON ANODE PARTICLES, IMIDAZOLE-FUNCTIONALIZED POLYMER BINDERS, AND ELECTRODES FOR FAST-CHARGING LITHIUM-ION BATTERIES

(71) Applicant: Aries Science and Technology, LLC, Westerville, OH (US)

(72) Inventor: Ramanathan S. Lalgudi, Westerville, OH (US)

(21) Appl. No.: 19/647,485

(22) Filed: Apr. 14, 2026

Related U.S. Application Data
(60) Provisional application No. 63/788,792, filed on Apr. 14, 2025.

(51) Int. Cl. H01M 4/60; C08F 8/32; C09D 5/24; C09D 7/20; C09D 7/62; C09D 133/02; H01M 4/36; H01M 4/62

(52) U.S. Cl. CPC H01M 4/602; C08F 8/32; C09D 5/24; C09D 7/20; C09D 7/62; C09D 133/02; H01M 4/366; H01M 4/622; H01M 4/625

(57) ABSTRACT

Compositions and methods are disclosed for fast-charging silicon-based lithium-ion batteries meeting the energy density and cycle life requirements of unmanned aerial systems and other high-performance applications. Three classes of Si/SiOx anode particle surface modification are provided: organosilylation using silylating reagents including hexamethyldisilazane to yield organosiloxy Si—O—Si(CH₃)₃ surface groups; phosphorylation with phosphoric acid, polyphosphoric acid, or phosphonate reagents including DTPMP to yield surface organophosphate ester groups; and direct surface grafting with poly(vinyl methyl ether-alt-maleic anhydride) (PVME-MA) via anhydride ring-opening reaction with surface silanol groups to form covalent Si—O—CO— ester bonds, confirmed by acid value titration. Polymer binder compositions include PVME-MA functionalized with 1-(3-aminopropyl)imidazole (PVME-MA-Im) yielding amic acid and imide linkages with pendant imidazole groups; imidazole-modified polyacrylic acid; aziridine-crosslinked polyacrylic acid; PEG diglycidyl ether-crosslinked polyacrylic acid; and polybenzimidazole-containing polyacrylic acid. All binder compositions are electrochemically stable at 4.5 V or above versus Li/Li⁺. Electrode compositions combining PVME-MA surface-grafted Si/SiOx particles with PVME-MA-Im binder provide an integrated active material-binder system in which the same polymer backbone serves dual roles through selective sequential reactivity with surface silanol groups and aminoalkyl-imidazole modifiers, including in a single reaction vessel.

### RELATED APPLICATIONS

This application claims the priority benefit of U.S. Provisional Patent Application Ser. No. 63/788,792, filed 14 Apr. 2025, incorporated herein by reference.

### FIELD OF THE INVENTION

The present invention relates to lithium-ion batteries capable of fast charging, and more particularly to silicon-based anode materials, polymer binder compositions, and particle surface modification chemistries that address the cycle life, adhesion, and rate capability limitations that have prevented silicon anodes from meeting the energy density and fast-charging demands of unmanned aerial systems, electric vehicles and other high-performance applications.

### Introduction

Silicon anodes offer theoretical specific capacities of approximately 3,500-3,800 mAh/g, nearly ten times that of conventional graphite anodes (372 mAh/g), making silicon-based lithium-ion batteries an attractive platform for applications demanding high energy density and fast charging. Realizing this potential in practice has proven difficult. Silicon undergoes volumetric expansion of approximately 280-300% during lithiation, causing particle fracture, electrode delamination, and continuous reformation of the solid-electrolyte interphase (SEI) on freshly exposed surfaces. Each SEI reformation cycle consumes lithium inventory irreversibly, degrading capacity over time. Additional challenges include poor intrinsic electronic conductivity (~10⁻³ S/cm) and the formation of a brittle crystalline Li₁₅Si₄ phase below 50 mV during deep lithiation. Fast charging at rates of 10 C or above exacerbates all of these failure modes simultaneously, through rapid volumetric cycling and elevated electrode temperatures, and no existing commercial silicon anode system meets the combined requirements of 10 C charge rate, greater than 1,000 cycles, and greater than 80% capacity retention at cell-level specific energies exceeding 200 Wh/kg.

### Surface SiOH Groups

Commercially available Si and Si/SiOx particles carry an amorphous silicon oxide shell bearing surface silanol (SiOH) groups. These groups are a persistent source of electrode degradation: they participate in undesired side reactions with electrolyte components, consume binder carboxyl groups through irreversible esterification during electrode drying, and adsorb atmospheric moisture during electrode processing. Managing SiOH reactivity is therefore a prerequisite for achieving stable, high-rate silicon anode performance. Prior efforts have explored passivation of Si particle surfaces through silanization chemistry. Jiang et al. in “Surface-Functionalized Silicon Nanoparticles as Anode Material for Lithium-Ion Battery,” ACS Appl. Mater. Interfaces, 2018, 10(51), 44924-44931, DOI: 10.1021/acsami.8b17729 demonstrated that attaching epoxy-terminated groups to Si nanoparticle surfaces via reaction of silanol-enriched particles with functional silanes yielded improved cell performance and enhanced anode laminate adhesion strength relative to unmodified particles, attributed to covalent bond formation between the epoxy surface groups and a polyacrylic acid binder.

### Polymer Binder

The choice of polymer binder is important for silicon anode performance. Polyvinylidene fluoride (PVDF), the standard binder for graphite anodes, is inadequate for silicon due to insufficient adhesion and an inability to accommodate large volumetric changes. Polyacrylic acid (PAA) and its salts emerged as superior silicon binders due to carboxyl-group hydrogen bonding and esterification with surface SiOH. Crosslinked PAA systems have been explored: PAA-PEI networks (Chuang, Y.-P. et al., “Dual Cross-Linked Polymer Networks Derived from the Hyperbranched Poly(ethyleneimine) and Poly(acrylic acid) as Efficient Binders for Silicon Anodes in Lithium-Ion Batteries,” ACS Appl. Energy Mater., 2021, 4(2), 1583-1592, DOI: 10.1021/acsaem.0c02802); PAA-PVA elastic gels (WO2015/017418); borax-crosslinked PAA (Wang, S. et al., “Slime-Inspired Polyacrylic Acid-Borax Crosslinked Binder for High-Capacity Bulk Silicon Anodes in Lithium-Ion Batteries,” J. Power Sources, 2020, 468, 228365, DOI: 10.1016/j.jpowsour.2020.228365). Imidazole-containing acrylate copolymers have been described (US 20250019480, 2025), but these are radical copolymers of acrylic acid with imidazole-containing acrylate monomers, which differ fundamentally from the post-modification of preformed PVME-MA or PAA backbones disclosed herein.

### Poly(Vinyl Methyl Ether-Alt-Maleic Anhydride) as a Binder Platform

Poly(vinyl methyl ether-alt-maleic anhydride) (PVME-MA) is a well-characterized alternating copolymer with reactive maleic anhydride groups, used commercially in adhesives, personal care formulations, and drug delivery systems. Its application as a binder for silicon-based battery anodes, its direct covalent grafting to Si/SiOx particle surfaces via anhydride ring-opening with surface SiOH groups, and its functionalization with aminoalkyl imidazole to yield PVME-MA-Im binders with superior fast-charging performance, have not previously been described. The low glass transition temperature of the vinyl methyl ether backbone (Tg≈−25 °C) provides inherent elastic compliance suited to accommodating silicon's large volume changes, while the reactive anhydride groups offer a versatile platform for simultaneous particle surface grafting and pendant functional group introduction.

### Unmet Application Requirements

High performance batteries demand 10 C charging rates, 3 C discharge rates, cycle life exceeding 1,000 cycles at greater than 80% capacity retention, and cell-level specific energy exceeding 200 Wh/kg. These requirements define a performance envelope that existing silicon anode materials, surface modification chemistries, and binder compositions have not simultaneously achieved. The compositions and methods disclosed herein address this unmet need through three independently patentable inventive concepts: chemically surface-modified Si/SiOx particles, PVME-MA-based binder compositions, and modified PAA binder compositions, all directed toward enabling fast-charging lithium-ion batteries meeting or exceeding these demanding specifications.

### SUMMARY OF THE INVENTION

In a first aspect, the invention provides a lithium-ion battery electrode composition comprising: (a) silicon/silicon oxide (Si/SiOx, 0<x≤2) particles comprising a surface silicon oxide layer having covalently grafted copolymer chains attached through Si—O—CO— ester bonds formed by ring-opening of maleic anhydride groups of an anhydride-containing copolymer with surface silanol groups of the silicon oxide layer, and characterizable by a reduction in acid value relative to the acid value of the anhydride-containing copolymer after complete hydrolysis with water; and (b) a binder comprising an anhydride-containing copolymer functionalized with an aminoalkyl imidazole compound, the functionalized copolymer comprising amic acid moieties and pendant imidazole groups.

Any aspects of the invention can be further characterized by one or any combination of the following: wherein the anhydride-containing copolymer in (a) and (b) is independently selected from poly(vinyl methyl ether-alt-maleic anhydride) (PVME-MA), poly(styrene-alt-maleic anhydride), poly(ethylene-alt-maleic anhydride), poly(isobutylene-alt-maleic anhydride), poly(maleic anhydride-alt-1-octadecene), poly(propylene-graft-maleic anhydride), poly(vinylidene fluoride-graft-maleic anhydride), and combinations thereof; wherein the anhydride-containing copolymer in both (a) and (b) is poly(vinyl methyl ether-alt-maleic anhydride) (PVME-MA); wherein the PVME-MA has a weight-average molecular weight of 80,000 to 800,000 g/mol, or 80,000 to 400,000 g/mol, or 150,000 to 300,000 g/mol; wherein the aminoalkyl imidazole compound has the formula H₂N—(CH₂)ₙ-Im, wherein n is an integer from 2 to 5 and Im is an imidazole ring; wherein the aminoalkyl imidazole compound is 1-(3-aminopropyl)imidazole and is present at 5-50 mol %, or 10-40 mol %, or 20-30 mol %, relative to maleic anhydride repeat units of the copolymer in (b); wherein the reduction in acid value characterizing covalent grafting in element (a) is at least 10%, or 10-50%, or 15-30%, relative to the acid value of the water-hydrolyzed anhydride-containing copolymer control; wherein the reduction in acid value is at least 15%, or 15-40%, or 18-35%, relative to the acid value of the water-hydrolyzed anhydride-containing copolymer control; wherein amic acid moieties predominate over imide linkages in the functionalized copolymer of element (b), as confirmed by Fourier-transform infrared spectroscopy showing a more intense amide I absorption at approximately 1665 cm⁻¹ relative to imide carbonyl absorptions at approximately 1700 and 1775 cm⁻¹; wherein the electrode exhibits a 90-degree peel strength of at least 40 N/m, or 40-100 N/m, or 50-80 N/m, as measured by peel adhesion testing of the electrode laminate from a copper current collector foil; comprising a carbon conductor selected from carbon black, multi-walled carbon nanotubes, graphene, and combinations thereof, wherein Si/SiOx particles constitute 40-80 wt %, the carbon conductor constitutes 5 -25 wt %, and the binder constitutes 10-20 wt % of the dry electrode composition; wherein the Si/SiOx particles further comprise surface groups selected from: (i) organosiloxy groups of the formula —O—SiR₃, wherein R is independently C₁-C₈ alkyl or aryl; (ii) organophosphate ester groups of the formula —O—P(O)(OR′)ₙ, wherein R′ is hydrogen or C₁-C₄ alkyl and n is 1 or 2; (iii) organophosphonate groups derived from diethylenetriamine penta(methylene phosphonic acid) (DTPMP) bonded to the silicon oxide surface through Si—O—P bonds and comprising pendant amine groups available for covalent amide bond formation with carboxyl groups of the binder; and (iv) combinations thereof; in addition to the covalently grafted anhydride copolymer chains of element (a); wherein the functionalized anhydride-containing copolymer binder of element (b) is electrochemically stable at potentials up to 4.5 V or greater versus Li/Li⁺, as characterizable by cyclic voltammetry showing no significant oxidation current (0.05 mA/cm² or less) at potentials up to 4.5 V versus Li/Li⁺; wherein the functionalized anhydride-containing copolymer binder of element (b) further comprises imide linkages as a minor product, in addition to the amic acid moieties (the imide linkages can be formed by thermal cyclization of amic acid intermediates at temperatures above 140 °C).

In another aspect, the invention provides an intermediate in the form of a slurry comprising any of the electrode compositions described herein dispersed in N-methyl-2-pyrrolidone (NMP), wherein the carbon conductor comprises carbon black and multi-walled carbon nanotubes, and the slurry exhibits a viscosity of 2,000-5,000 cP, or 2,500-4,000 cP, or 2,800-3,500 cP, as measured by Brookfield viscometry at 25 °C at 10 rpm.

In a further aspect, the invention provides a method of preparing a lithium-ion battery electrode composition comprising: (a) combining Si/SiOx (0<x≤2) particles with an anhydride-containing copolymer comprising maleic anhydride repeat units in an organic solvent to form a mixture, and maintaining the mixture at a temperature of 40-120 °C, or 40-80 °C, or 50-70 °C, for a time sufficient to form covalent Si—O—CO— ester bonds between maleic anhydride groups of the copolymer and surface silanol groups of the Si/SiOx particles, wherein covalent ester bond formation is characterizable by a reduction in acid value relative to the acid value of the anhydride-containing copolymer after complete hydrolysis with water; (b) adding, to the same mixture and without isolation of the surface-grafted particles, an aminoalkyl imidazole compound at 5-50 mol %, or 10-40 mol %, or 20-30 mol %, relative to the total maleic anhydride repeat units of the anhydride-containing copolymer; (c) heating the mixture to 100-140 °C, or 110-130 °C, or 115-125 °C, under inert atmosphere for 8-16 hours, or 10-14 hours, or 11-13 hours, to functionalize residual maleic anhydride groups with amic acid moieties and pendant imidazole groups; and (d) casting the resulting mixture onto a current collector and drying to form an electrode; wherein steps (a) through (d) are performed using the same reaction mixture without isolation of any intermediate.

The method can be further characterized by one or any combination of the following; wherein the reduction in acid value characterizing covalent ester bond formation in step (a) is at least 10%, or 10-50%, or 15-30%, relative to the acid value of the water-hydrolyzed anhydride-containing copolymer control; wherein the anhydride-containing copolymer is poly(vinyl methyl ether-alt-maleic anhydride) (PVME-MA) and the aminoalkyl imidazole compound is 1-(3-aminopropyl)imidazole; wherein the organic solvent is N-methyl-2-pyrrolidone (NMP), step (a) is performed at 40-60 °C for 1-4 hours, and step (c) is performed at 115-125 °C for 11-13 hours under argon; wherein the acid value reduction confirming covalent ester bond formation in step (a) is measurable by withdrawing a sample of the mixture prior to aminoalkyl imidazole addition in step (b) and performing acid value titration on the withdrawn sample; further comprising, prior to step (a), surface-modifying the Si/SiOx particles by a method selected from: (i) reacting the Si/SiOx particles with an organosilylating agent to convert surface silanol groups to organosiloxy groups of the formula —O—SiR₃; (ii) reacting the Si/SiOx particles with a phosphorylating agent selected from phosphoric acid, phosphorous acid, polyphosphoric acid, and diethylenetriamine penta(methylene phosphonic acid) (DTPMP) via azeotropic condensation to convert surface silanol groups to organophosphate ester groups; and (iii) combinations thereof.

In another aspect, the invention provides a polymer binder for a lithium-ion battery anode comprising a polyacrylic acid backbone wherein 1-50 mol %, or 5-30 mol %, or 5 -15 mol %, of carboxyl groups have been converted to amide groups of the formula —CO—NH—(CH₂)ₙ-Im, wherein n is an integer from 2 to 5 and Im is an imidazole ring. Preferably, the aminoalkyl imidazole compound is 1-(3-aminopropyl)imidazole and the degree of modification is 5 -15 mol %, or 8-12 mol % and/or which is electrochemically stable at potentials up to 4.5 V or greater versus Li/Li⁺, as determined by cyclic voltammetry.

In a further aspect, the invention provides a polymer binder for a lithium-ion battery anode comprising a polyacrylic acid backbone crosslinked through β-amino ester crosslinks formed with a polyfunctional aziridine crosslinker, wherein the crosslinked binder possesses a storage modulus of at least 50 MPa, or 50-200 MPa, or 70-120 MPa, as measurable by dynamic mechanical analysis at ambient temperature, and a 90-degree peel strength of at least 30 N/m, or 30-80 N/m, or 35-55 N/m, as measurable by peel adhesion testing from a copper current collector foil.

In another aspect, the invention provides a polymer binder for a lithium-ion battery anode comprising a reaction product of polyacrylic acid with poly(ethylene glycol) diglycidyl ether (PEGDGE, number-average molecular weight 200-10,000 g/mol, or 500-2,000 g/mol) catalyzed by a Lewis acid selected from Al(ClO₄)₃, Mg(ClO₄)₂, Cr(ClO₄)₃, BF₃ etherate, Zn(OTf)₂, La(OTf)₃, and combinations thereof.

In another aspect, the invention provides a polymer binder for a lithium-ion battery anode comprising a polyacrylic acid backbone wherein at least 5 mol %, or 5-40 mol %, or 10-30 mol %, of carboxyl groups are incorporated into pendant benzimidazole ring structures through amide bonds to a 1,2-phenylenediamine unit, the binder being electrochemically stable to 5.0 V versus Li/Li⁺ as measurable by cyclic voltammetry showing no significant oxidation current (0.05 mA/cm² or less) up to 5.0 V versus Li/Li⁺.

In a further aspect, the invention provides a composition comprising Si/SiOx (0<x≤2) particles having surface organophosphate ester groups of the formula —O—P(O)(OR)n, wherein R is hydrogen or C₁-C₄ alkyl and n is 1 or 2, characterizable by ³¹P solid-state NMR spectroscopy showing a chemical shift at approximately −10 ppm and by FTIR spectroscopy showing a P—O—Si absorption at approximately 900-1000 cm⁻¹ and a P═O absorption at approximately 1200-1250 cm⁻¹.

In another aspect, the invention provides a composition comprising Si/SiOx (0<x≤2) particles having surface organophosphonate groups derived from diethylenetriamine penta(methylene phosphonic acid) (DTPMP) bonded to the silicon oxide surface through Si—O—P bonds, characterizable by ³¹P solid-state NMR spectroscopy and FTIR spectroscopy, and further comprising pendant primary amine groups detectable by X-ray photoelectron spectroscopy nitrogen signal or a ninhydrin assay, said pendant amine groups being reactive toward carboxyl groups of a polymer binder to form covalent amide bonds upon heating to 80 °C to 120 °C, as confirmable by the appearance of an amide absorption at approximately 1650-1680 cm⁻¹ in FTIR spectroscopy following contact with polyacrylic acid (PAA) at the temperature of from 80 °C to 120 °C.

In another aspect, the invention provides a lithium-ion battery comprising: (a) an anode comprising any of the electrode compositions described herein; (b) a cathode comprising a lithium metal oxide active material; (c) a separator; and (d) an electrolyte. Preferably, the cathode active material is selected from LiNi_{0.8}Mn_{0.1}Co_{0.1}O₂ (NMC811), LiFePO₄ (LFP), LiNiCoAlO₂ (NCA), and combinations thereof, and/or wherein the electrolyte comprises a solid electrolyte selected from LAGP, LATP, LLTO, Li₆La₂CaTa₂O₁₂, Li₆La₂ANb₂O₁₂, Li₂S—P₂S₅, and polymer-ceramic composites thereof. Preferably, the battery possesses a cycle life of at least 1,000 cycles at greater than 80% capacity retention when charged at a C-rate of 10 C and discharged at a C-rate of 3 C, and a cell-level specific energy exceeding 200 Wh/kg.

In a further aspect, the invention provides a method of surface-modifying Si/SiOx (0<x≤2) particles comprising reacting the Si/SiOx particles with a phosphorylating agent selected from phosphoric acid, phosphorous acid, polyphosphoric acid, red phosphorus, diethylenetriamine penta(methylene phosphonic acid) (DTPMP), and combinations thereof, in an azeotropic solvent at 100-160 °C, or 110-140 °C, or 115-135 °C, with continuous azeotropic removal of water, to convert surface silanol groups to surface organophosphate ester groups of the formula —O—P(O)(OR)n, wherein R is hydrogen or C₁-C₄ alkyl and n is 1 or 2. Preferably, the phosphorylating agent is DTPMP, whereby terminal amine groups of surface-bound DTPMP are retained as pendant amine groups characterizable by X-ray photoelectron spectroscopy nitrogen signal or a ninhydrin assay and available for subsequent covalent amide bond formation with carboxyl groups of a polymer binder.

In another aspect, the invention provides a method of preparing the polymer binder of claim 22, comprising condensing a polyacrylic acid backbone with an aminoalkyl imidazole compound at 100-140 °C, or 110-130 °C, or 115-125 °C, in N-methyl-2-pyrrolidone, to convert 1-50 mol %, or 5-30 mol %, or 5 -15 mol %, of carboxyl groups to amide groups of the formula —CO—NH—(CH₂)ₙ-Im.

In a further aspect, the invention provides a method of preparing the polymer binder of claim 25, comprising reacting polyacrylic acid with a polyfunctional aziridine crosslinker having at least two aziridine ring groups per molecule at 0.5-10 wt %, or 1-7 wt %, or 2-4 wt %, relative to polyacrylic acid, to form β-amino ester crosslinks.

As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of.” As used in this specification, the terms “includes” or “including” should not be read as limiting the invention but, rather, listing exemplary components.

The invention is further elucidated in the examples below. The invention may be further characterized by any selected descriptions from the examples, for example, within ±20% (or within ±10%) of any of the values in any of the examples; however, the scope of the present invention, in its broader aspects, is not intended to be limited by these examples. All ranges are inclusive and combinable. For example, when a range of “1 to 5’ is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

### BRIEF DESCRIPTION OF THE DRAWINGS

FIG. 1 illustrates the synthesis of imidazole-functionalized poly(vinyl methyl ether-alt-maleic anhydride) binder (PVME-MA-Im). The alternating maleic anhydride copolymer PVME-MA reacts with 1-(3-aminopropyl)imidazole (API) in N-methyl-2-pyrrolidone (NMP) at 120 °C. The primary amine of API undergoes nucleophilic ring-opening of the maleic anhydride groups to yield, as the major product, an amic acid-imidazole copolymer in which each reacted maleic unit bears one amide bond (—CO—NH—(CH₂)₃-Im) and one free carboxylic acid group (—COOH), with a pendant propylimidazole group; and, as a minor product, an imide-imidazole copolymer in which the reacted maleic unit has undergone full cyclization to a five-membered N-substituted imide ring. The relative proportions of amic acid and imide products are controlled by reaction temperature and time as described herein.

FIG. 2A illustrates the direct covalent surface grafting of Si/SiOx particles with PVME-MA. Surface silanol (SiOH) groups on the amorphous SiOx shell of Si/SiOx particles undergo ring-opening reaction with maleic anhydride groups of PVME-MA to form covalent Si—O—CO— ester bonds, tethering the polymer directly to the particle surface. The adjacent carbonyl of the ring-opened maleic unit becomes a free carboxylic acid group (—COOH) available for further hydrogen bonding with carbon conductors and the copper current collector, or for crosslinking with the surrounding binder network. The figure illustrates the conversion of a surface passivation liability—reactive SiOH groups—into a productive covalent bonding opportunity, creating an integrated surface-grafted binder architecture.

FIG. 2B illustrates the phosphorylation of Si/SiOx particle surface SiOH groups. Surface silanol groups undergo condensation with phosphoric acid and related phosphorylating agents via azeotropic water removal to yield covalent Si—O—P(O)(OR)n surface phosphate ester moieties. The figure illustrates representative phosphorylating agents within scope, including phosphoric acid (H₃PO₄), phosphorous acid (H₃PO₃), polyphosphoric acid, and diethylenetriamine penta(methylene phosphonic acid) (DTPMP). For DTPMP-modified particles, terminal amine groups remaining after surface phosphorylation are available for subsequent covalent reaction with binder carboxyl groups, providing a bifunctional particle-to-binder covalent coupling bridge.

FIG. 3 illustrates the synthesis of imidazole-modified polyacrylic acid binder (Imid-PAA). Carboxyl groups of a preformed PAA backbone undergo condensation with 1-(3-aminopropyl)imidazole in NMP at 120 °C to yield amide linkages (—CO—NH—(CH₂)₃-Im) with pendant propylimidazole groups. The degree of modification, expressed as mole percent of carboxyl groups converted to amide-imidazole groups, is controlled by the stoichiometry of API addition as described herein. Unreacted carboxyl groups are retained for hydrogen bonding with Si/SiOx particle surfaces, carbon conductors, and the copper current collector.

FIG. 4 partially illustrates the synthesis of aziridine-crosslinked PAA. Carboxyl groups of a PAA backbone react with a polyfunctional aziridine crosslinker, specifically trimethylolpropane tris(2-methylaziridine-1-propanoate), via aziridine ring-opening to form β-amino ester crosslinks between PAA chain segments. The trifunctional crosslinker architecture creates a three-dimensional network with improved storage modulus and peel strength relative to uncrosslinked PAA.

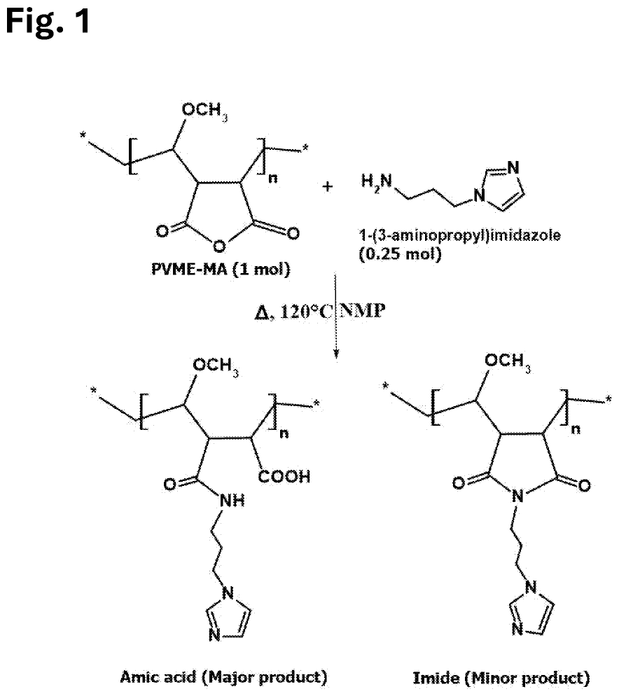

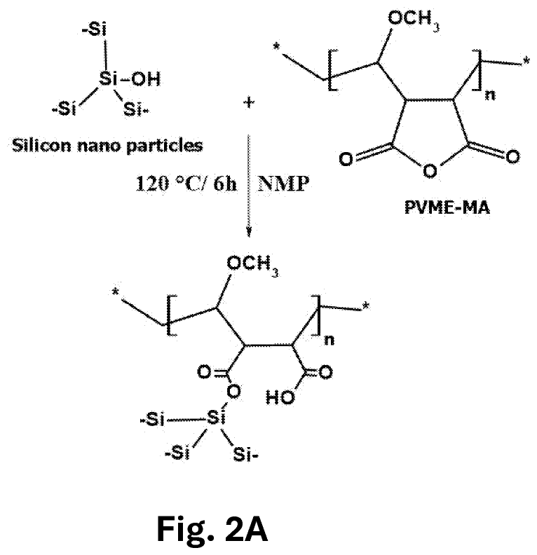

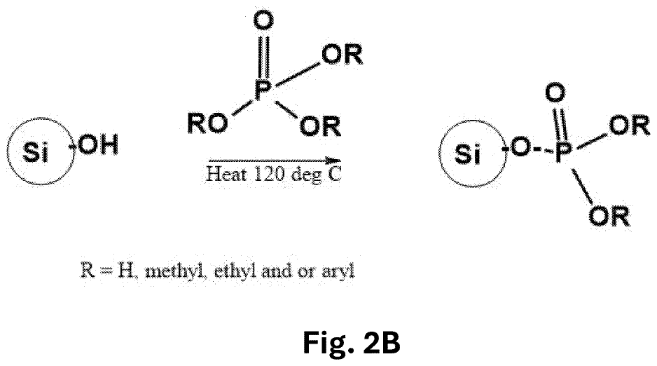

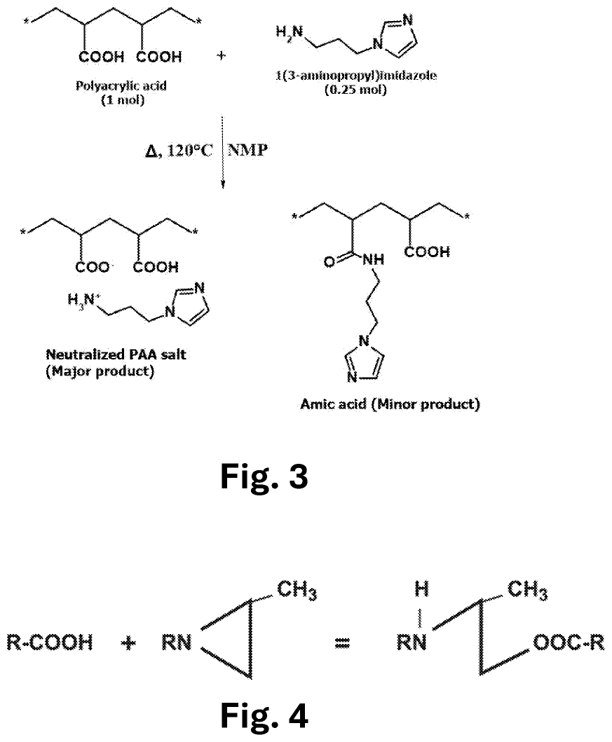

### GLOSSARY

Unless otherwise defined herein, all technical and scientific terms used in this application have their ordinary meaning as understood by one of ordinary skill in the relevant arts of polymer chemistry, electrochemistry, surface chemistry, and materials science. The following definitions apply throughout this specification and claims.

“Si/SiOx” means silicon particles comprising a crystalline silicon core and an amorphous silicon oxide shell of composition SiOx, wherein 0<x≤2. The amorphous shell typically arises from native oxidation of the crystalline silicon surface and carries surface silanol (SiOH) groups available for chemical modification. Si/SiOx particles preferably have a mean particle diameter of 20 nm to 10 μm.

“Surface silanol group” or “SiOH group” means a silicon-bound hydroxyl group (≡Si—OH) present on the surface of the amorphous SiOx shell of Si/SiOx particles. Surface silanol groups are the reactive sites for three classes of surface modification disclosed herein: organosilylation, phosphorylation, and anhydride ring-opening grafting.

“PVME-MA” means poly(vinyl methyl ether-alt-maleic anhydride), an alternating copolymer comprising vinyl methyl ether repeat units and maleic anhydride repeat units in approximately 1:1 molar ratio. PVME-MA has a glass transition temperature of approximately −25 °C (minus 25 C), imparting elastic compliance to binder compositions prepared therefrom. Suitable molecular weights range from 80,000 to 800,000 g/mol. PVME-MA is commercially available, for example as Gantrez® AN series polymers.

“PVME-MA-Im” means PVME-MA that has been functionalized by reaction of at least a portion of its maleic anhydride groups with an aminoalkyl imidazole compound, as disclosed herein, to yield a copolymer bearing pendant imidazole groups connected through amic acid moieties and, optionally, imide linkages. PVME-MA-Im preferably refers to the product of reaction with 1-(3-aminopropyl)imidazole at 5-50 mol % relative to maleic anhydride repeat units.

“Maleic anhydride group” means the cyclic anhydride repeat unit of PVME-MA, comprising two carbonyl groups and one ring oxygen in a five-membered ring. Maleic anhydride groups are electrophilic and undergo ring-opening reactions with nucleophiles including primary amines, hydroxyl groups, and surface silanol groups as disclosed herein.

“Amic acid product” means the half-ring-opened product formed by reaction of a maleic anhydride group with a primary amine nucleophile, comprising one amide bond (—CO—NH—R) to the amine-bearing substituent and one free carboxylic acid group (—COOH) on the adjacent carbonyl. The amic acid product is the major product of PVME-MA reaction with 1-(3-aminopropyl)imidazole at 120 °C in NMP for 12 hours.

“Imide product” means the fully cyclized product formed by dehydration of an amic acid intermediate, comprising a five-membered N-substituted imide ring. The relative proportion of imide product increases with reaction temperature above 140 °C and with extended reaction times. Under the preferred reaction conditions of 120 °C in NMP for 12 hours, the imide product is obtained as the minor product relative to the amic acid product.

“Surface-grafted binder” means a polymer binder that is covalently bonded to the surface of Si/SiOx particles through direct chemical reaction between reactive groups on the polymer and surface SiOH groups on the particles, occurring during electrode fabrication or a preceding particle treatment step. A surface-grafted binder is distinguished from a physically adsorbed binder in that covalent bonds between the polymer and the particle surface persist under the mechanical and electrochemical stresses of battery cycling.

“Si—O—CO— ester bond” means a covalent ester linkage formed between a surface silanol group (Si—OH) of a Si/SiOx particle and a carbonyl group of a maleic anhydride unit of PVME-MA or PVME-MA-Im, having the connectivity Si—O—C(═O)—. Formation of Si—O—CO— ester bonds can be confirmed by acid value titration as described herein.

“Acid value” means the mass of potassium hydroxide in milligrams required to neutralize free carboxylic acid groups in one gram of a polymer sample, determined by titration with standardized KOH solution using phenolphthalein as indicator, expressed in units of mg KOH/g. Acid value titration is used herein as a quantitative analytical method to confirm covalent reaction between PVME-MA anhydride groups and Si/SiOx surface SiOH groups, as a reduction in acid value relative to a fully water-hydrolyzed control indicates that a fraction of anhydride groups have reacted with Si—OH rather than with water, forming Si ester bonds that do not contribute to titratable acidity.

“Organosiloxy group” means a surface substituent of the formula —O—SiR₃ formed by reaction of a surface SiOH group with an organosilylating agent, wherein R independently represents alkyl, aryl, or combinations thereof, and wherein the oxygen atom is covalently bonded to the silicon atom of the Si/SiOx particle surface. Organosiloxy groups passivate Si/SiOx particle surfaces by converting reactive SiOH groups to hydrophobic, chemically stable surface substituents. Organosiloxy groups can be confirmed by FTIR spectroscopy.

“Organophosphate ester moiety” means a surface group of the formula —O—P(O)(OR)n formed by condensation of a surface SiOH group with a phosphorylating agent, wherein R represents hydrogen, alkyl, or further connectivity to the phosphorylating agent backbone, and n is 1 or 2. Organophosphate ester moieties can be confirmed by ³¹P solid-state NMR and FTIR spectroscopy.

“PAA” means polyacrylic acid, a homopolymer of acrylic acid comprising repeat units of —CH₂—CH(COOH)—, preferably having a molecular weight of 100,000 to 1,000,000 g/mol unless otherwise specified. PAA and its lithium, sodium, and ammonium salts are within the scope of binder compositions disclosed herein.

“Imid-PAA” means PAA in which a portion of carboxyl groups have been converted to amide-imidazole groups by condensation with an aminoalkyl imidazole compound as disclosed herein.

“Aminoalkyl imidazole” or “API” means a compound of the formula H₂N—(CH₂)n-Im, wherein n is an integer from 2 to 5 and Im represents an imidazole ring. The preferred aminoalkyl imidazole is 1-(3-aminopropyl)imidazole, wherein n=3.

“Aziridine crosslinker” means a polyfunctional compound bearing two or more aziridine ring groups per molecule, capable of ring-opening reaction with carboxyl groups of PAA to form β-amino ester crosslinks. A preferred aziridine crosslinker is trimethylolpropane tris(2-methylaziridine-1-propanoate).

“Mean particle diameter” means the volume-weighted median diameter (D50) as determined by laser diffraction particle size analysis or, for particles below 100 nm, by dynamic light scattering (DLS) or transmission electron microscopy (TEM) image analysis.

“PEGDGE” means poly(ethylene glycol) diglycidyl ether, a difunctional epoxide crosslinker comprising a poly(ethylene glycol) chain terminated at both ends with glycidyl ether groups, having a number-average molecular weight of 200 to 10,000 g/mol. PEGDGE reacts with PAA carboxyl groups under Lewis acid catalysis to form ether-ester crosslinks with PEG segments providing elastic compliance and lithium ion solvation pathways.

“Lewis acid catalyst” means a metal salt capable of activating epoxide groups of PEGDGE toward ring-opening reaction with PAA carboxyl groups. Lewis acid catalysts include Al(ClO₄)₃, Mg(ClO₄)₂, Cr(ClO₄)₃, BF₃ etherate, Zn(OTf)₂, La(OTf)₃, and combinations thereof.

“Polybenzimidazole-containing PAA” or “PBI-PAA” means the product of condensation of PAA carboxyl groups with 1,2-phenylenediamine in polyphosphoric acid at elevated temperature, wherein a portion of PAA carboxyl groups are incorporated into benzimidazole ring structures. PBI-PAA binders are electrochemically stable to 5.0 V versus Li/Li⁺ and have thermal stability onset temperatures above 290 °C.

“Electrochemical stability” means the absence of observable oxidative or reductive decomposition of a binder composition, as determined by cyclic voltammetry showing no significant oxidation current up to the stated potential versus Li/Li⁺.

“Fast charging” means charging a lithium-ion battery cell or electrode at a C-rate of 5 C or greater.

“C-rate” means a measure of the rate at which a battery is charged or discharged relative to its theoretical capacity, wherein a C-rate of 1 C corresponds to full charge or discharge in one hour, 5 C to full charge or discharge in 12 minutes, and 10 C to full charge or discharge in 6 minutes.

“SEI” means solid-electrolyte interphase, the passivation layer formed on anode particle surfaces by reductive decomposition of electrolyte components during the first and subsequent charge cycles. SEI reformation on freshly fractured Si/SiOx particle surfaces is a primary mechanism of irreversible lithium consumption and capacity fade in silicon anodes.

“NMP” means N-methyl-2-pyrrolidone, an aprotic polar solvent used for dissolution of PVME-MA, PVME-MA-Im, PAA, and modified PAA binders in electrode slurry preparation.

“Areal capacity” means the electrochemical capacity of an electrode per unit geometric area, expressed in mAh/cm², determined by galvanostatic cycling as described herein.

“DTPMP” means diethylenetriamine penta(methylene phosphonic acid), a polyphosphonic acid compound bearing five phosphonic acid groups and three secondary amine groups. As a Si/SiOx surface modification agent, DTPMP provides covalent Si—O—P surface bonds through its phosphonic acid groups while retaining free amine groups for subsequent covalent reaction with polymer binder carboxyl groups, creating a bifunctional particle-to-binder covalent coupling bridge.

### DETAILED DESCRIPTION OF THE INVENTION

The following detailed description sets forth specific examples and aspects of the compositions and methods disclosed herein. The examples are illustrative and non-limiting. The full scope of the compositions and methods is defined by the claims. Reference is made to the Glossary for definitions of terms used herein.

### I. Surface Modification of Si/SiOx Particles

### A. Organosilylation

Si/SiOx particles carrying surface silanol (SiOH) groups on their amorphous oxide shell are reacted with an organosilylating agent to convert surface SiOH groups to hydrophobic, chemically stable organosiloxy groups (—O—SiR₃), thereby passivating the particle surface against undesired side reactions with electrolyte components and binder carboxyl groups during electrode fabrication and cycling.

Si/SiOx particles suitable for organosilylation typically have a mean particle diameter of 20 nm to 10 μm and preferably a BET surface area of 1 to 150 m²/g. The loading of organosilylating agent required to achieve a target surface coverage scales with BET surface area rather than geometric diameter, and can be determined by TGA of the product as described below.

In one example, Si/SiOx particles having a mean diameter of 20-500 nm are dried under vacuum at 120 °C for 12 hours to remove adsorbed moisture. Hexamethyldisilazane (HMDS) is added neat to the dried particles in a sealed glass vial, and the mixture is heated at 80 °C for 2 hours according to the reaction:

2Si—OH+(CH₃)₃Si—NH—Si(CH₃)₃→2Si—O—Si(CH₃)₃+NH₃

The product is washed twice with anhydrous isopropanol and dried under vacuum at 60 °C for 4 hours. Successful silylation is confirmed by FTIR spectroscopy: disappearance of the broad SiOH stretch at approximately 3200-3500 cm⁻¹ and appearance of Si—CH₃ absorption bands at approximately 840 and 1260 cm⁻¹. Thermogravimetric analysis (TGA) provides quantitative surface coverage: a weight loss of 2.3 wt % in the temperature range 150-550 °C corresponds to approximately 1.4 trimethylsilyl (TMS) groups per nm² of particle surface.

The silylation procedure is applicable to Si/SiOx particles across the full size range of 20 nm to 10 μm. For larger particles with lower BET surface area, the absolute loading of HMDS per gram of particles may be reduced proportionally while maintaining equivalent surface coverage expressed as silyl groups per nm². Reaction temperatures of 20-150 °C for durations of 30 minutes to 24 hours are suitable, conducted neat or in anhydrous aprotic solvents including tetrahydrofuran (THF), dimethylformamide (DMF), toluene, and dimethylsulfoxide (DMSO).

Alternative organosilylating agents within the scope of this disclosure include hexaethyldisilazane; tert-butyldimethylsilyl chloride (TBDMSCl); tert-butyldiphenylsilyl chloride (TBDPSCl); triethylsilyl chloride; and silyl imidazolide derivatives thereof.

The organosilylated Si/SiOx particles may be used directly in electrode fabrication with any of the polymer binder compositions disclosed herein, or may be subjected to further surface functionalization prior to electrode assembly.

### B. Phosphorylation

In another example of Si/SiOx surface modification, surface SiOH groups are converted to organophosphate ester moieties via azeotropic condensation with a phosphorylating agent:

Si—OH+HO—P(O)(OR)₂→Si—O—P(O)(OR)₂+H₂O

Si/SiOx particles suitable for phosphorylation preferably have a mean particle diameter of 20 nm to 10 μm and preferably a BET surface area of 1 to 150 m²/g. The azeotropic condensation procedure is applicable across this full size range, with reagent stoichiometry adjusted proportionally to particle BET surface area to achieve a target surface phosphorus loading.

In a representative procedure, Si/SiOx particles (10.0 g) and phosphoric acid (2.0 g, 85% aqueous solution) are combined in toluene or xylene (50 mL) in a round-bottom flask equipped with a Dean-Stark trap. The mixture is refluxed at 120-130 °C for 4-8 hours with continuous azeotropic removal of water, driving the condensation reaction to completion. The product is isolated by filtration, washed with ethanol (3×10 mL) to remove unreacted phosphorylating agent, and dried under vacuum at 100 °C for 8 hours. Surface phosphorylation is confirmed by ³¹P solid-state NMR spectroscopy (chemical shift δ≈−10 ppm, consistent with surface phosphate ester), FTIR spectroscopy (P—O—Si stretch at approximately 900-1000 cm⁻¹; P═O stretch at approximately 1200-1250 cm⁻¹), and ICP-OES elemental analysis (phosphorus content 0.8 wt % in the representative example). Electrochemical impedance spectroscopy (EIS) of half-cells incorporating phosphorylated Si/SiOx particles demonstrates a 35% reduction in charge-transfer resistance relative to unmodified Si/SiOx particles after 100 cycles, providing functional confirmation of improved surface stability.

Phosphorylating agents include phosphoric acid (H₃PO₄); phosphorous acid (H₃PO₃); polyphosphoric acid; red phosphorus; and diethylenetriamine penta(methylene phosphonic acid) (DTPMP). The use of DTPMP as a phosphorylating agent is a particularly useful aspect of this disclosure, as described in Section I.D below.

The phosphorylated Si/SiOx particles may be used in electrode fabrication with any of the polymer binder compositions disclosed herein. The organophosphate ester surface layer improves electrolyte compatibility, reduces parasitic side reactions at the particle surface, and provides a chemically distinct interface between the silicon oxide shell and the surrounding binder matrix.

### C. Direct Surface Grafting With PVME-MA

In a further example of Si/SiOx surface modification, the problem of reactive surface SiOH groups is addressed not by passivation but by productive exploitation: the anhydride groups of PVME-MA undergo ring-opening reaction with surface SiOH groups, grafting the polymer covalently to the particle surface and converting a liability into a bonding opportunity. The ring-opening reaction proceeds as follows:

Si—OH+[PVME-MA maleic anhydride unit]→Si—O—CO—CH═CH—COOH

One carbonyl of the maleic anhydride forms a covalent Si—O—CO— ester bond with the surface silanol group, tethering the polymer chain directly to the particle surface. The adjacent carbonyl becomes a free carboxylic acid group (—COOH). The resulting surface-grafted PVME-MA layer provides: (a) a covalently anchored polymer coating on each Si/SiOx particle; (b) residual free carboxyl groups for hydrogen bonding with carbon conductors and the copper current collector; and (c) residual unreacted maleic anhydride groups available for further functionalization with aminoalkyl imidazole to yield a surface-grafted PVME-MA-Im layer, as described in Section II.B below.

Si/SiOx particles suitable for PVME-MA surface grafting have a mean particle diameter of 20 nm to 10 μm and a BET surface area of 1 to 150 m²/g. Higher BET surface area particles provide a greater number of surface SiOH groups per gram of particles and correspondingly higher degrees of surface grafting at equivalent PVME-MA loading, as quantified by acid value titration as described below.

In a representative procedure, PVME-MA (molecular weight 80,000-800,000 g/mol) is dissolved in NMP at 6-10 wt % at 60 °C. Si/SiOx particles are added and the suspension is mixed at 40-60 °C for 1-4 hours. The mixture is cast onto copper foil and dried at 80-120 °C, during which anhydride ring-opening with surface SiOH groups is completed. The surface-grafted Si/SiOx-PVME-MA composite may be used directly as an electrode or the grafted particles may be isolated by filtration or centrifugation for further characterization or functionalization.

Covalent surface grafting is confirmed by acid value titration. When PVME-MA undergoes hydrolysis with water, both carbonyls of each maleic anhydride unit yield free carboxylic acid groups, producing a maximum acid value. When PVME-MA instead reacts with surface SiOH groups, one carbonyl per reacted anhydride unit forms a Si ester bond that does not contribute to titratable acidity, reducing the observed acid value relative to the water-hydrolysis control. In a representative experiment, the acid value of PVME-MA recovered after reaction with Si/SiOx particles and drying (391 mg KOH/g) was approximately 18% lower than the water-hydrolysis control (476 mg KOH/g), confirming that approximately 18% of maleic anhydride groups reacted covalently with surface SiOH groups under mild conditions (60 °C, 2 hours). Higher surface coverage is achieved during electrode drying at 100-120 °C. This acid value titration method provides a practical analytical tool for confirming covalent surface grafting and quantifying surface coverage without requiring specialized solid-state NMR or synchrotron characterization facilities.

The degree of surface grafting, expressed as the percentage reduction in acid value relative to the water-hydrolysis control, is expected to vary with particle BET surface area, reaction temperature, reaction time, and PVME-MA molecular weight. Higher BET surface area, higher reaction temperature, longer reaction time, and lower molecular weight each favor increased surface grafting. The acid value titration method described herein provides a practical means of optimizing these parameters for a given particle lot and target surface coverage.

### D. DTPMP as a Bifunctional Particle-to-Binder Coupling Agent

DTPMP, when used as the phosphorylating agent in the procedure of Section I.B, provides a bifunctional particle-to-binder covalent coupling architecture not available with simple phosphoric acid or polyphosphoric acid. DTPMP bears five phosphonic acid groups and three secondary amine groups per molecule. The phosphonic acid groups react with surface SiOH groups via condensation to form covalent Si—O—P bonds anchoring the DTPMP molecule to the particle surface. The terminal amine groups of surface-bound DTPMP remain available for subsequent covalent reaction with carboxyl groups of the polymer binder during electrode fabrication, forming amide bonds that create a continuous covalent bridge from the Si/SiOx particle surface through the DTPMP coupling layer to the polymer binder matrix. This architecture is distinguished from simple surface passivation in that it creates a fully covalent particle-binder interface rather than relying on hydrogen bonding or physical adsorption between binder and particle. The DTPMP coupling layer is expected to maintain mechanical integrity of the electrode under the large volumetric strains associated with silicon lithiation and delithiation, particularly at fast charging rates where strain rates are elevated.

The DTPMP surface modification procedure follows the general condensation procedure of Section I.B, substituting DTPMP for phosphoric acid at an equivalent phosphonate group stoichiometry relative to surface SiOH groups. The DTPMP-modified Si/SiOx particles may be used with any of the polymer binder compositions disclosed in Section II, with covalent amide bond formation between surface amine groups and binder carboxyl groups occurring during electrode drying.

### II. Polymer Binder Compositions

### A. PVME-MA as a Standalone Surface-Reactive Binder

Unfunctionalized PVME-MA is useful as a silicon anode binder by exploiting its reactive maleic anhydride groups to simultaneously achieve two functions during electrode fabrication: covalent grafting to Si/SiOx particle surface SiOH groups via Si—O—CO— ester bond formation as described in Section I.C, and provision of a flexible, elastic binder matrix through its vinyl methyl ether backbone segments (T^{G}≈−25 °C) that accommodates silicon volumetric expansion during lithiation and contraction during delithiation. The ring-opening of maleic anhydride with surface SiOH generates adjacent free carboxyl groups that provide further adhesion to carbon conductors and the copper foil current collector through hydrogen bonding interactions.

The PVME-MA binder matrix may be further crosslinked after surface grafting through either of two routes: reaction of residual carboxyl groups with a polyfunctional amine or aziridine crosslinker as described in Section II.D; or thermal imidization of amic acid intermediates at temperatures above 160 °C, converting amic acid groups to imide rings with concurrent dehydration, increasing the crosslink density and thermal stability of the binder network.

Molecular weights of PVME-MA in the range of 80,000 to 800,000 g/mol are suitable for binder applications. Higher molecular weight grades provide greater chain entanglement and cohesive strength; lower molecular weight grades provide lower solution viscosity and improved processability at equivalent solids content. The binder solution concentration in NMP is preferably 5-15 wt % for electrode slurry preparation. Polymer molecular weights refer to weight average molecular weight unless otherwise indicated.

### B. PVME-MA-Im Binder

PVME-MA is functionalized with 1-(3-aminopropyl)imidazole (API) by nucleophilic ring-opening of maleic anhydride groups with the primary amine of API to yield PVME-MA-Im, a binder combining the elastic compliance and surface reactivity of the PVME-MA backbone with pendant imidazole groups that provide lithium ion coordination sites and strong adhesion to carbon conductor surfaces.

The ring-opening reaction proceeds as:

Maleic anhydride unit+H₂N—(CH₂)₃-Im→amic acid product (major)+imide product (minor)

The amic acid product, which predominates at 120 °C in NMP for 12 hours, contains one amide bond (—CO—NH—(CH₂)₃-Im) and one free carboxyl group (—COOH) per reacted maleic unit. The imide product, formed as a minor product under these conditions, contains a five-membered N-substituted imide ring. The relative proportion of imide product increases with reaction temperature above 140 °C and extended reaction times, and may be increased intentionally where greater thermal and chemical stability of the binder linkages is desired.

In a representative synthesis procedure, PVME-MA (8.0 g, molecular weight approximately 216,000 g/mol) is dissolved in NMP (92 g) at 60 °C to yield an 8 wt % solution. API (1.42 g) is added dropwise with stirring at ambient temperature at a stoichiometry of 25 mol % relative to maleic anhydride repeat units. The mixture is heated to 120 °C under argon in a sealed reactor for 12 hours. The product PVME-MA-Im solution is used directly as a 5-8 wt % binder solution in NMP for electrode slurry preparation without isolation of the solid polymer.

Characterization of PVME-MA-Im can be observed by FTIR spectroscopy: substantial reduction of anhydride carbonyl absorptions at approximately 1850 and 1780 cm⁻¹; appearance of amide I absorption at approximately 1665 cm⁻¹ attributable to the amic acid product (major); imide carbonyl absorptions at approximately 1700 and 1775 cm⁻¹ (minor); and imidazole ring absorption at approximately 1510 cm⁻¹. ¹H NMR spectroscopy in DMSO-d₆ shows imidazole ring protons at δ 6.9-7.5 ppm, confirming 25 mol % functionalization.

The molar ratio of API to maleic anhydride repeat units is preferably 0.05 to 0.50, more preferably 0.20 to 0.30. At loadings below 0.05, the concentration of pendant imidazole groups is insufficient to provide meaningful improvement in lithium ion coordination or carbon conductor adhesion. At loadings above 0.50, the concentration of residual unreacted maleic anhydride groups available for surface grafting to Si/SiOx particles is reduced to a degree that may compromise the surface-grafted binder architecture.

At 25 mol % API loading, approximately 75% of maleic anhydride groups in PVME-MA-Im remain unreacted and available for covalent reaction with surface SiOH groups of Si/SiOx particles during electrode fabrication. This creates a dual-function architecture in which PVME-MA-Im is simultaneously grafted to the Si/SiOx particle surface through Si—O—CO— ester bonds and carries pendant imidazole groups for lithium ion coordination and carbon conductor adhesion. This integrated architecture establishes a continuous covalent connection between the active material particle surface and the surrounding binder matrix while maintaining the electrochemical functionality of the imidazole groups. PVME-MA-Im binder compositions are electrochemically stable at potentials up to 4.5 V or greater versus Li/Li⁺, as confirmed by cyclic voltammetry showing no significant oxidation current up to this potential.

### C. Imidazole-Modified Polyacrylic Acid Binder (Imid-PAA)

PAA (molecular weight 100,000-1,000,000 g/mol, preferably approximately 400,000-450,000 g/mol) is functionalized with API by condensation of PAA carboxyl groups with the primary amine of API in NMP at elevated temperature, yielding amide bonds with pendant propylimidazole groups:

PAA-COOH+H₂N—(CH₂)₃-Im→PAA-CO—NH—(CH₂)₃-Im+H₂O

In a representative procedure, PAA (8.0 g, molecular weight approximately 450,000 g/mol) is dissolved in NMP (92 g) at 60 °C. API (1.4 g) is added dropwise at a stoichiometry of 10 mol % relative to carboxyl repeat units. The mixture is heated to 120 °C under argon for 12 hours. Successful amide bond formation is confirmed by FTIR spectroscopy showing amide I absorption at approximately 1655 cm⁻¹ and amide II absorption at approximately 1545 cm⁻¹, and by ¹H NMR spectroscopy in DMSO-d₆ showing imidazole ring protons at δ 6.9-7.5 ppm confirming 10 mol % modification.

The degree of modification is preferably 5 -15 mol % of carboxyl groups. The majority of PAA carboxyl groups remain unreacted and available for hydrogen bonding with Si/SiOx particle surfaces, carbon conductors, and the copper current collector, preserving the adhesion properties that make PAA a useful silicon anode binder while adding the lithium ion coordination functionality of the pendant imidazole groups. Imid-PAA binder compositions are electrochemically stable at potentials up to 4.5 V or greater versus Li/Li⁺.

### D. Aziridine-Crosslinked PAA

PAA carboxyl groups react with a polyfunctional aziridine crosslinker via aziridine ring-opening to form β-amino ester crosslinks between PAA chain segments, creating a three-dimensional binder network with improved mechanical properties relative to uncrosslinked PAA. In a representative procedure, PAA (5.0 g, molecular weight 250,000 g/mol) is dissolved in NMP (45 g) to yield a 10 wt % solution. Trimethylolpropane tris(2-methylaziridine-1-propanoate) (0.15 g, 3 wt % relative to PAA) is added at ambient temperature. The mixture has a pot life of approximately 30 minutes after crosslinker addition, within which it must be cast onto the electrode substrate. The cast electrode is cured at 130 °C for 2 hours to complete crosslinking. Dynamic mechanical analysis (DMA) of the cured binder film shows a storage modulus of approximately 85 MPa at ambient temperature. Ninety-degree peel strength testing of the electrode laminate yields 42 N/m, compared to 18 N/m for an uncrosslinked PAA baseline, representing a 2.3-fold improvement in adhesion.

These functional properties—storage modulus and peel strength as determined by DMA and 90-degree peel testing respectively—provide a practical basis for confirming the presence of the crosslinked binder architecture in electrode laminates and for establishing infringement of claims directed to the crosslinked binder compositions. Storage modulus values of at least 50 MPa and peel strength values of at least 30 N/m are achievable across the full range of crosslinker loadings and PAA molecular weights disclosed herein, with the representative example demonstrating approximately 85 MPa and 42 N/m respectively.

The crosslinker loading is preferably 0.5-10 wt % relative to PAA. At loadings below 0.5 wt %, the crosslink density is insufficient to provide meaningful improvement in mechanical properties. At loadings above 10 wt %, the pot life may be reduced to a degree that compromises electrode coating processability, and excessive crosslink density may reduce the elastic compliance needed to accommodate Si volumetric expansion.

### E. PEG Diglycidyl Ether-Crosslinked PAA

PAA carboxyl groups react with poly(ethylene glycol) diglycidyl ether (PEGDGE, number-average molecular weight 200-10,000 g/mol, preferably 500-2,000 g/mol) under Lewis acid catalysis to form ether-ester crosslinks, with PEG segments providing elastic compliance and lithium ion solvation pathways through the binder matrix.

In a representative procedure, PAA (4.0 g, molecular weight 400,000 g/mol) is dissolved in NMP (36 g). PEGDGE (molecular weight 700 g/mol, 0.4 g) and aluminum perchlorate (Al(ClO₄)₃, 0.8 mol % relative to epoxide groups, approximately 8 mg), are added. The mixture is heated at 80 °C for 4 hours. Half-cells incorporating PEGDGE-crosslinked PAA binder show 28% improved capacity retention relative to neat PAA binder after 300 cycles at C/3 rate.

Lewis acid catalysts within the scope of this disclosure include Al(ClO₄)₃, Mg(ClO₄)₂, Cr(ClO₄)₃, BF₃ etherate, Zn(OTf)₂, La(OTf)₃, and combinations thereof. The Lewis acid activates the epoxide groups of PEGDGE toward ring-opening by PAA carboxyl groups, enabling crosslinking at moderate temperatures of 60-120 °C and practical reaction times of 2-8 hours. The molecular weight of PEGDGE controls the length and flexibility of the crosslink segments: shorter PEG chains (molecular weight 200-500 g/mol) provide stiffer crosslinks with higher crosslink density at equivalent loading; longer PEG chains (molecular weight 1,000-10,000 g/mol) provide more compliant crosslinks and longer lithium ion solvation pathways.

### F. Polybenzimidazole-Containing PAA Binder (PBI-PAA)

PAA carboxyl groups undergo condensation with 1,2-phenylenediamine in polyphosphoric acid (PPA) at elevated temperature (e.g., 160 °C-220 °C) to form pendant benzimidazole rings incorporated into the PAA backbone, yielding a binder with exceptional electrochemical stability and thermal resistance.

In a representative procedure, PAA (3.0 g, molecular weight 100,000 g/mol) and 1,2-phenylenediamine (0.65 g, 30 mol % cyclization relative to carboxyl groups) are dissolved in PPA (30 g) at 80 °C. The mixture is heated to 200 °C for 3 hours under nitrogen. The product is precipitated in ice-cold methanol, filtered, washed, and dried under vacuum at 120 °C for 24 hours. TGA confirms thermal stability onset above 295 °C. Cyclic voltammetry shows no oxidation current to 5.0 V versus Li/Li⁺, representing the highest electrochemical stability ceiling of the binder compositions disclosed herein.

The degree of benzimidazole cyclization is desirably at least 5 mol % of carboxyl groups, preferably 10-30 mol %. Residual unreacted carboxyl groups are retained for adhesion to Si/SiOx particle surfaces and current collector foil. The benzimidazole rings provide aromatic π-system interactions with carbon conductor surfaces, contributing to electrode cohesion through both covalent network formation and non-covalent stacking interactions.

### III. Anode Electrode Fabrication

Anode electrodes can be fabricated by the following general procedure, with variations as noted. Si/SiOx particles are optionally surface-modified per any of the procedures of Sections I.A through I.D prior to slurry preparation. A binder solution is prepared per any of the procedures of Sections II.A through II.F in NMP or water at 5-20 wt % solids. An electrode slurry is formulated comprising Si/SiOx particles (40-80 wt % of dry electrode), carbon conductor (5-25 wt % of dry electrode), and binder (10-20 wt % of dry electrode). Suitable carbon conductors include carbon black (e.g., Super C65), carbon nanotubes (CNTs), graphene, and combinations thereof.

In a representative electrode fabrication procedure using PVME-MA-Im binder, Si/SiOx (70 wt %), carbon black (Super C65, 10 wt %), MWCNTs (5 wt %), and PVME-MA-Im binder solution (15 wt % dry binder) are combined in NMP and mixed using a planetary centrifugal mixer at 2,000 rpm for 15 minutes. Slurry viscosity is approximately 3,100 cP (Brookfield, 25 °C, 10 rpm). The slurry is cast onto copper foil at 150 μm wet thickness and dried at 100 °C for 30 minutes. The dried electrode is calendered at 80 °C to a final thickness of 42 μm, porosity of 34%, and areal capacity of 2.1 mAh/cm². Peel strength of the calendered electrode is 61 N/m. Optional hot calendering at 60-120 °C to a porosity of 30-40% improves electronic conductivity of the electrode by reducing interparticle contact resistance and increases volumetric energy density by reducing electrode thickness at equivalent areal capacity.

### IV. Peel Adhesion Test Method

The adhesion strength of electrode laminates to copper current collector foil is determined by a 90-degree peel adhesion test as described herein. This method provides a quantitative measure of the mechanical bond between the electrode coating and the current collector, which is a critical determinant of electrode integrity during battery cycling, particularly for silicon-based anodes that undergo large volumetric changes.

Test Specimen Preparation: Electrode laminates are prepared by casting the electrode slurry onto battery-grade copper foil (8-12 μm thickness, surface roughness Ra<1 μm) using a doctor blade at a wet gap of 100-200 μm, followed by drying at 80-120 °C for 20-60 minutes. The dried electrode is optionally calendered as described in Section III. The dried and calendered electrode laminate is cut into test specimens of 25 mm width and at least 100 mm length using a precision cutting die. Specimen edges must be clean and free of delamination, burring, or cracking. Minimum of three specimens from different locations across the coated foil are prepared per sample.

Tape Application: A strip of double-coated pressure-sensitive adhesive tape (3M 9690, or equivalent with peel adhesion≥500 N/m to steel) is applied to the electrode coating surface of each specimen with firm hand pressure, using a 2 kg roller applied twice at a rate of approximately 300 mm/minute, to ensure complete contact between the tape backing and the electrode surface. The tape width equals the specimen width (25 mm). The adhesive tape provides the rigid backing needed to peel the electrode coating away from the copper foil at a controlled angle without deformation of the thin electrode layer.

Test Configuration: The copper foil end of the specimen is fixed to the lower jaw of a universal testing machine (Instron 3343) equipped with a 50 N load cell calibrated within the preceding 12 months. A 90-degree peel fixture is used, wherein the copper foil end of the specimen is secured horizontally to a flat movable platform and the tape-backed electrode end is gripped vertically in the upper jaw, maintaining a 90-degree peel angle throughout the test. The peel direction is along the length of the specimen. Alternatively, the tape backing may be gripped in the upper jaw and the copper foil secured to a horizontal substrate fixture, with the same 90-degree geometry maintained.

Test Parameters: The crosshead displacement rate is 30 mm/minute (0.5 mm/s). A pre-load of 0.05 N is applied before data acquisition begins. Load versus displacement data is recorded at a minimum sampling rate of 10 Hz. The test is run for a minimum travel distance of 50 mm after the initial peel propagation transient (first 5 mm of peel travel is discarded).

Calculation: Peel strength is reported in units of N/m, calculated as the average load (in Newtons) over the stable peel region (excluding the first 5 mm and last 5 mm of peel travel) divided by the specimen width (in meters, 0.025 m for a 25 mm specimen). The result is the average of at least three specimens. The standard deviation and coefficient of variation are reported alongside the mean. The mode of failure (adhesive failure at the electrode-foil interface, cohesive failure within the electrode coating, or mixed mode) is recorded for each specimen.

Representative Values: Using this protocol, the following peel strength values have been measured: uncrosslinked PAA binder: 18 N/m; aziridine-crosslinked PAA (3 wt % crosslinker): 42 N/m (2.3-fold improvement); PVME-MA-Im binder (25 mol % API, 70 wt % Si, calendered): 61 N/m. These values are consistent with the peel strength requirements recited in claims 10 and 25 of the present disclosure.

### V. Full Lithium-Ion Battery Cell

A lithium-ion battery cell incorporating the anode electrodes described herein comprises: an anode per Section III; a cathode comprising a lithium metal oxide active material; a separator; and a liquid or solid electrolyte. Suitable cathode active materials include NMC811 (LiNi_{0.8}Mn_{0.1}Co_{0.1}O₂), LFP (LiFePO₄), and NCA (LiNiCoAlO₂). Suitable solid electrolytes include LAGP, LATP, LLTO, Li₆La₂CaTa₂O₁₂, Li₆La₂ANb₂O₁₂, Li₂S—P₂S₅, and polymer-ceramic composites thereof.

Target performance parameters for full cells incorporating the compositions disclosed herein are: 10 C charge rate; 3 C discharge rate; cycle life exceeding 1,000 cycles at greater than 80% capacity retention; and cell-level specific energy exceeding 200 Wh/kg. These parameters correspond to the performance requirements of U.S. Army small unmanned aerial system (sUAS) applications and represent a demanding performance envelope that the disclosed compositions are designed to meet.

1. A lithium-ion battery electrode composition comprising:
(a) silicon/silicon oxide (Si/SiOx, 0<x≤2) particles comprising a surface silicon oxide layer having covalently grafted copolymer chains attached through Si—O—CO— ester bonds formed by ring-opening of maleic anhydride groups of an anhydride-containing copolymer with surface silanol groups of the silicon oxide layer, and characterizable by a reduction in acid value relative to the acid value of the anhydride-containing copolymer after complete hydrolysis with water; and
(b) a binder comprising an anhydride-containing copolymer functionalized with an aminoalkyl imidazole compound, the functionalized copolymer comprising amic acid moieties and pendant imidazole groups.

2. The electrode composition of claim 1, wherein the anhydride-containing copolymer in (a) and (b) is independently selected from poly(vinyl methyl ether-alt-maleic anhydride) (PVME-MA), poly(styrene-alt-maleic anhydride), poly(ethylene-alt-maleic anhydride), poly(isobutylene-alt-maleic anhydride), poly(maleic anhydride-alt-1-octadecene), poly(propylene-graft-maleic anhydride), poly(vinylidene fluoride-graft-maleic anhydride), and combinations thereof.

3. The electrode composition of claim 1, wherein the anhydride-containing copolymer in both (a) and (b) is poly(vinyl methyl ether-alt-maleic anhydride) (PVME-MA).

4. The electrode composition of claim 1, wherein the PVME-MA has a weight-average molecular weight of 80,000 to 800,000 g/mol, or 80,000 to 400,000 g/mol, or 150,000 to 300,000 g/mol.

5. The electrode composition of claim 1, wherein the aminoalkyl imidazole compound has the formula H₂N—(CH₂)ₙ-Im, wherein n is an integer from 2 to 5 and Im is an imidazole ring.

6. The electrode composition of claim 1, wherein the aminoalkyl imidazole compound is 1-(3-aminopropyl)imidazole and is present at 5-50 mol %, or 10-40 mol %, or 20-30 mol %, relative to maleic anhydride repeat units of the copolymer in (b).

7. The electrode composition of claim 1, wherein the reduction in acid value characterizing covalent grafting in element (a) is at least 10%, or 10-50%, or 15-30%, relative to the acid value of the water-hydrolyzed anhydride-containing copolymer control.

8. The electrode composition of claim 1, wherein the reduction in acid value is at least 15%, or 15-40%, or 18-35%, relative to the acid value of the water-hydrolyzed anhydride-containing copolymer control.

9. The electrode composition of claim 1, wherein amic acid moieties predominate over imide linkages in the functionalized copolymer of element (b), as confirmable by Fourier-transform infrared spectroscopy showing a more intense amide I absorption at approximately 1665 cm⁻¹ relative to imide carbonyl absorptions at approximately 1700 and 1775 cm⁻¹.

10. The electrode composition of claim 1, wherein the electrode exhibits a 90-degree peel strength of at least 40 N/m, or 40-100 N/m, or 50-80 N/m, as measurable by peel adhesion testing of the electrode laminate from a copper current collector foil.

11. The electrode composition of claim 1, further comprising a carbon conductor selected from carbon black, multi-walled carbon nanotubes, graphene, and combinations thereof, wherein Si/SiOx particles constitute 40-80 wt %, the carbon conductor constitutes 5-25 wt %, and the binder constitutes 10-20 wt % of the dry electrode composition.

12. An intermediate in the form of a slurry comprising the electrode composition of claim 1 dispersed in N-methyl-2-pyrrolidone (NMP), wherein the carbon conductor comprises carbon black and multi-walled carbon nanotubes, and the slurry exhibits a viscosity of 2,000-5,000 cP, or 2,500-4,000 cP, or 2,800-3,500 cP, as measurable by Brookfield viscometry at 25 °C at 10 rpm.

13. The electrode composition of claim 1, wherein the Si/SiOx particles further comprise surface groups selected from:
(i) organosiloxy groups of the formula —O—SiR₃, wherein R is independently C₁-C₈ alkyl or aryl;
(ii) organophosphate ester groups of the formula —O—P(O)(OR′)ₙ, wherein R′ is hydrogen or C₁-C₄ alkyl and n is 1 or 2;
(iii) organophosphonate groups derived from diethylenetriamine penta(methylene phosphonic acid) (DTPMP) bonded to the silicon oxide surface through Si—O—P bonds and comprising pendant amine groups available for covalent amide bond formation with carboxyl groups of the binder; and
(iv) combinations thereof;
in addition to the covalently grafted anhydride copolymer chains of element (a) of claim 1.

14. The electrode composition of claim 1, wherein the functionalized anhydride-containing copolymer binder of element (b) is electrochemically stable at potentials up to 4.5 V or greater versus Li/Li⁺, as characterizable by cyclic voltammetry showing no significant oxidation current (0.05 mA/cm² or less) at potentials up to 4.5 V versus Li/Li⁺.

15. The electrode composition of claim 1, wherein the functionalized anhydride-containing copolymer binder of element (b) further comprises imide linkages as a minor product, in addition to the amic acid moieties.

16. A method of preparing a lithium-ion battery electrode composition comprising:
(a) combining Si/SiOx (0<x≤2) particles with an anhydride-containing copolymer comprising maleic anhydride repeat units in an organic solvent to form a mixture, and maintaining the mixture at a temperature of 40-120 °C, or 40-80 °C, or 50-70 °C, for a time sufficient to form covalent Si—O—CO— ester bonds between maleic anhydride groups of the copolymer and surface silanol groups of the Si/SiOx particles, wherein covalent ester bond formation is characterizable by a reduction in acid value relative to the acid value of the anhydride-containing copolymer after complete hydrolysis with water;
(b) adding, to the same mixture and without isolation of the surface-grafted particles, an aminoalkyl imidazole compound at 5-50 mol %, or 10-40 mol %, or 20-30 mol %, relative to the total maleic anhydride repeat units of the anhydride-containing copolymer;
(c) heating the mixture to 100-140 °C, or 110-130 °C, or 115-125 °C, under inert atmosphere for 8-16 hours, or 10-14 hours, or 11-13 hours, to functionalize residual maleic anhydride groups with amic acid moieties and pendant imidazole groups; and
(d) casting the resulting mixture onto a current collector and drying to form an electrode;
wherein steps (a) through (d) are performed using the same reaction mixture without isolation of any intermediate.

17. The method of claim 16, wherein the reduction in acid value characterizing covalent ester bond formation in step (a) is at least 10%, or 10-50%, or 15-30%, relative to the acid value of the water-hydrolyzed anhydride-containing copolymer control.

18. The method of claim 16, wherein the anhydride-containing copolymer is poly(vinyl methyl ether-alt-maleic anhydride) (PVME-MA) and the aminoalkyl imidazole compound is 1-(3-aminopropyl)imidazole.

19. (canceled)

20. (canceled)

21. The method of claim 16, further comprising, prior to step (a), surface-modifying the Si/SiOx particles by a method selected from:
(i) reacting the Si/SiOx particles with an organosilylating agent to convert surface silanol groups to organosiloxy groups of the formula —O—SiR₃;
(ii) reacting the Si/SiOx particles with a phosphorylating agent selected from phosphoric acid, phosphorous acid, polyphosphoric acid, and diethylenetriamine penta(methylene phosphonic acid) (DTPMP) via azeotropic condensation to convert surface silanol groups to organophosphate ester groups; and
(iii) combinations thereof.

22. A polymer binder for a lithium-ion battery anode comprising a polyacrylic acid backbone wherein 1-50 mol %, or 5-30 mol %, or 5-15 mol %, of carboxyl groups have been converted to amide groups of the formula —CO—NH—(CH₂)ₙ-Im, wherein n is an integer from 2 to 5 and Im is an imidazole ring.

23-36. (canceled)
